(19) United States
(12) Patent Application Publication
(10) Pub. No.: US 2015/0347305 A1
(43) Pub. Date: Dec. 3, 2015

(54) METHOD AND APPARATUS FOR OUTPUTTING LOG INFORMATION

(71) Applicant: Tencent Technology (Shenzhen) Company Limited, Shenzhen (CN)

(72) Inventor: Siguang LI, Shenzhen (CN)

(73) Assignee: Tencent Technology (Shenzhen) Company Limited, Shenzhen (CN)

(21) Appl. No.: 14/824,469

(22) Filed: Aug. 12, 2015

Related U.S. Application Data
(63) Continuation of application No. PCT/CN2014/080705, filed on Jun. 25, 2014.

(30) Foreign Application Priority Data
Jun. 26, 2013 (CN) 201310260929.3

(51) Int. Cl. G06F 12/08

(52) U.S. Cl. CPC G06F 12/0875; G06F 12/0893; G06F 2212/463

(57) ABSTRACT

A method and an apparatus for outputting log information are disclosed in the field of information technology. In the method: a system thread acquires a plurality of pieces of log information from a plurality of application threads. The system thread establishes a log information cache queue. The system thread caches each piece of the log information from the plurality of pieces of log information into the established log information cache queue. The system thread configures the log information located in the front of the log information cache queue, into a log file.

### CROSS-REFERENCE TO RELATED APPLICATIONS

This application is a continuation of International Application No. PCT/CN2014/080705, filed on Jun. 25, 2014, which claims priority to Chinese Patent Application No. 201310260929.3, filed on Jun. 26, 2013, both of which are incorporated herein by reference in their entireties.

### FIELD

The present disclosure relates to the field of information technology, in particular to a method and an apparatus for outputting log information.

### BACKGROUND

Along with the continuous development of terminal devices, there are more and more types of application programs in the terminal devices. In general, in a process of running an application program, there are always a plurality of threads which exist simultaneously, and each thread has a large amount of log information, which needs to be outputted to a log information sharing file, for the purpose of debugging and positioning problems in the process of running the application program.

At present, various threads configure their respective log information into the log information sharing file according to a certain order, i.e., when a certain thread is performing an operation of configuring the log information, which has been outputted, into the log information sharing file, other threads need to wait until this thread has completed the operation of configuring the log information into the log information sharing file and can then configure the log information into the log information sharing file again. Therefore, outputting the log information through the existing output mode of log information will make the waiting time become relatively long before the various threads configure the log information into the log information sharing file, and the operation time consumed for the various threads to configure the log information, which has been outputted, into the log information sharing file is also relatively long, so as to cause the task execution efficiency of the various threads to be relatively low.

### SUMMARY

The embodiments of the present disclosure disclose a method and an apparatus for outputting log information and can improve the task execution efficiency of various threads.

In a first aspect, a method for outputting log information is provided. The method is implemented in a device having a processor. The device includes a system thread acquires a plurality of pieces of log information from a plurality of application threads. The system thread establishes a log information cache queue. The system thread caches each piece of the log information from the plurality of pieces of log information into the established log information cache queue. The system thread configures the log information located in the front of the log information cache queue, into a log file.

In a second aspect, an apparatus for outputting log information is provided. The apparatus includes a hardware processor and a non-transitory storage medium configured to store the following units implemented by the hardware processor: an acquiring unit, a caching unit, and a configuring unit. The acquiring unit is configured to acquire a plurality of pieces of log information which have been outputted by a plurality of application threads. The caching unit is configured to cache each piece of the log information from the plurality of pieces of log information acquired by the acquiring unit in proper order into a log information cache queue which has been established by a system thread. The configuring unit is configured to configure the log information, which is cached by the caching unit and located in the front of the log information cache queue, into a log file.

In a third aspect, a device is provided for outputting log information, including a processor and a non-transitory storage medium accessible to the processor. The device is configured to: establish a log information cache queue by a system thread in the device; acquire a plurality of pieces of log information outputted from a plurality of application threads; cache each piece of the log information from the plurality of pieces of log information acquired by the acquiring unit into the log information cache queue; and configure the log information located in the front of the log information cache queue, into a log file.

The method and the apparatus, which are disclosed in the embodiments of the present disclosure, for outputting the log information include first acquiring the plurality of pieces of log information which have been outputted by the plurality of application threads, then caching each piece of the log information from the plurality of pieces of log information in proper order into the log information cache queue which has been established by the system thread and finally configuring the log information, which is located in the front of the log information cache queue, into the log information sharing file. In comparison with the current situation whereby the various threads directly configure their respectively outputted log information into the log information sharing file according to the certain order, i.e., when a certain thread is performing an operation of configuring the log information, which has been outputted, into the log information sharing file, other threads need to wait until this thread has completed the operation of configuring the log information into the log information sharing file and can then configure the log information into the log information sharing file again, the embodiments of the present disclosure establish and maintain one log information cache queue through the configuration of an independent system thread, acquire the log information from this log information cache queue through the system thread and configure the log information, which has been acquired, into the log information sharing file to make other threads be capable of executing other tasks immediately just after having cached the log information, which has been outputted, into this log information cache queue but not need to wait for the completion of the operation of configuring the log information, which has been outputted, into the log information sharing file prior to executing other tasks, so as to improve the task execution efficiency and performance of the various threads.

### BRIEF DESCRIPTION OF THE DRAWINGS

In order to more clearly explain the technical solution in the embodiments of the present disclosure, a brief introduction is given to the attached drawings required for use in the description of the embodiments or prior art below. Obviously, the attached drawings in the following description are merely some embodiments of the present disclosure, and for those of ordinary skill in the art, they may also acquire other drawings according to these attached drawings under the precondition of not making creative efforts.

FIG. 1 shows a flow diagram of a method, which is disclosed in the embodiments of the present disclosure, for outputting log information;

FIG. 2 shows a flow diagram of another method, which is disclosed in the embodiments of the present disclosure, for outputting log information;

FIG. 3 shows an example structural schematic diagram of an apparatus, which is disclosed in the embodiments of the present disclosure, for outputting log information;

FIG. 4 shows an example structural schematic diagram of another apparatus, which is disclosed in the embodiments of the present disclosure, for outputting log information; and

FIG. 5 shows an example schematic diagram of a log information cache queue disclosed in the embodiments of the present disclosure.

### DETAILED DESCRIPTION OF THE DRAWINGS

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client may be stationary or mobile.

A server, as used herein, may refer to one or more server computers configured to provide certain server functionalities, such as database management and search engines. A server may also include one or more processors to execute computer programs in parallel.

The solutions in the embodiments of the present disclosure are clearly and completely described in combination with the attached drawings in the embodiments of the present disclosure. Obviously, the described embodiments are only a part, but not all, of the embodiments of the present disclosure. On the basis of the embodiments of the present disclosure, all other embodiments acquired by those of ordinary skill in the art under the precondition that no creative efforts have been made shall be covered by the protective scope of the present disclosure.

In order to further clarify the advantages of the solutions in the present disclosure, the present disclosure is further described in detail in combination with the attached drawings and the embodiments below.

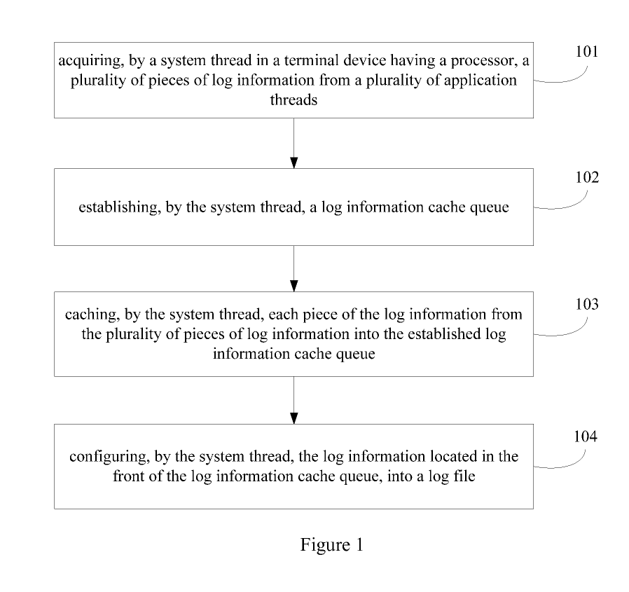

The embodiments of the present disclosure disclose a method for outputting the log information; as shown in FIG. 1, the method includes:

101: A system thread in a terminal device acquires a plurality of pieces of log information from a plurality of application threads. The system thread may acquire the plurality of pieces of log information which have been outputted by the plurality of application threads running in the terminal device.

Here, when an application thread runs, there may be a large amount of log information to be outputted, where the log information is configured to record result data of various operations performed in the process of running various application threads.

102: The system thread establishes a log information cache queue. To improve efficiency and reduce the waiting time for the various application threads, the log information cache queue

103: The device caches each piece of the log information from the plurality of pieces of log information into the established log information cache queue. The device may cache each piece of the log information from the plurality of pieces of log information in a proper order into the log information cache queue.

Here, the log information cache queue may be configured to save the log information which has been outputted by different application threads. For example, the log information may be a memory address to which the cached log information corresponds or any other form. The embodiments of the present disclosure do not set any limit to the form of the log information. The operation in which the various application threads cache the log information, which has been outputted, into the log information cache queue is performed in the memory, and the time consumed for the caching operation in the memory is very short. Thus, this operation significantly reduces the time consumed for the operation and further improves the task execution efficiency of the various threads in comparison with the operation in which the various application threads directly configure the log information into the log information sharing file.

For the embodiments of the present disclosure, the terminal device establishes and maintains a log information cache queue using an independent system thread. The terminal device then acquires the log information from this log information cache queue through the system thread so as to complete the operation of configuring the log information into the log information sharing file. The size of the log information cache queue may be configured according to the memory size of the terminal device. An example data structure of the log information cache queue is shown below:

```
    struct student
    {
      void* queue[QUEUE_SIZE];
  int head;
      int tail;
      bool full;
    bool empty;
}
```

Here, “queue” represents a pointer to the log information, and it is used for identifying a position of the log information in a pointer array. The constant “QUEUE_SIZE” represents the length of the pointer array of the log information, and it is used for identifying the length of the log information cache queue. The integer variable “head” represents a dequeue subscript position of the log information, and it is used for identifying a position of the log information, which has been acquired from the log information cache queue, in the pointer array. The integer variable “tail” represents an enqueue subscript position of the log information, and it is used for identifying a position of the log information, which needs to be saved into the log information cache queue, in the pointer array. The Boolean variable “full” is used for identifying whether there is any remaining storage space in the log information cache queue or not. The Boolean variable “empty” is used for identifying whether the log information cache queue is empty or not.

As the log information cache queue in the embodiments of the present disclosure is a shared resource under a plurality of threads, it is necessary to add a mutual exclusion lock to the log information cache queue at the time of performing the operations of saving the log information into the log information cache queue and of acquiring the log information from the log information cache queue so as to ensure the integrity of the operation of the shared resource. Unlock the log information cache queue after having completed the operations.

For the embodiments of the present disclosure, the process to realize the specific procedure of caching the log information into the log information cache queue may include: first adding the mutual exclusion lock to this log information cache queue prior to caching the log information into the log information cache queue, then determining whether a “full” flag to which the log information cache queue corresponds is true or not; if the flag is true, it is indicated that the memory space of the log information cache queue is full and is not capable of saving this log information; at this time, unlocking this log information cache queue, and then transmitting a prompt message to the system thread, which maintains this log information cache queue, so as to prompt the system thread that the log information that can be acquired and configured into the log information sharing file exists in the log information cache queue. If the “full” flag to which the log information cache queue corresponds is false, it is indicated that the memory space of the log information cache queue is not full; at this time, assigning the pointer to this log information to a “queue” array, the subscript position of which is “tail,” so as to complete the enqueue operation of this log information, then unlocking the log information cache queue, and transmitting a prompt message to the system thread so as to prompt the system thread that the log information, which may be configured into the log information sharing file, exists in the log information cache queue.

Here, the process of determining whether the memory space of the log information cache queue is full or not can specifically include: adding 1 to a “tail” value after having assigned the pointer to any one piece of log information to the “queue” array, the subscript position of which is “tail”; determining whether the current “tail” value is equal to the maximum length of the array or not; if it is equal to the maximum length of the array, configuring the “tail” value to 0, then determining whether the “tail” value is equal to a “head” value or not; if it is unequal to the maximum length of the array, directly determining whether the “tail” value is equal to the “head” value or not; when the “tail” value is equal to the “head” value, it is indicated that the enqueue operation of the log information has always been performed in this cache queue, but there is no dequeue operation of the log information in the cache queue, or the amount of the log information for the enqueue operation is larger than the amount of the log information for the dequeue operation, and the difference between the amounts is equal to the upper limit of the amount of the log information which can be cached into the log information cache queue, which causes the memory space of the log information cache queue to become full, and at this time, configuring the “full” flag to “true.” When the “tail” value is unequal to the “head” value, it is indicated that the amount of the log information for the enqueue operation and the amount of the log information for the dequeue operation are kept balanced in this cache queue, which causes the memory space of the log information cache queue to never become full, and at the moment, configuring the “full” flag to “false” so as to identify that the memory space of the current log information cache queue is not full yet and to indicate that this log information can be saved at this time.

104: The system thread configures the log information located in the front of the log information cache queue, into a log file. For example, the system thread may configure the log information, which is located in the front of the log information cache queue, into a log information sharing file.

Here, the log information sharing file may specifically be a device file or a regular file and may be configured to save the log information which has been outputted by various threads. The log information cache queue in the embodiments of the present disclosure may specifically be a first-in, first-out queue, so acquiring the log information from the log information cache queue is to acquire one piece of log information from the front.

The method, which is disclosed in the embodiments of the present disclosure, for outputting the log information includes first acquiring the plurality of pieces of log information which have been outputted by the plurality of application threads, then caching each piece of the log information from the plurality of pieces of log information in proper order into the log information cache queue which has been established by the system thread and finally configuring the log information, which is located in the front of the log information cache queue, into the log information sharing file. In comparison with the current situation whereby the various threads directly configure their respectively outputted log information into the log information sharing file according to the certain order, i.e., when a certain thread is performing an operation of configuring the log information, which has been outputted, into the log information sharing file, other threads need to wait until this thread has completed the operation of configuring the log information into the log information sharing file and can then configure the log information into the log information sharing file again, the embodiments of the present disclosure establish and maintain one log information cache queue through the configuration of an independent system thread, acquire the log information from this log information cache queue through the system thread and configure the log information, which has been acquired, into the log information sharing file to make other threads be capable of executing other tasks immediately just after having cached the log information, which has been outputted, into this log information cache queue but not need to wait for the completion of the operation of configuring the log information, which has been outputted, into the log information sharing file prior to executing other tasks, so as to improve the task execution efficiency and performance of the various threads.

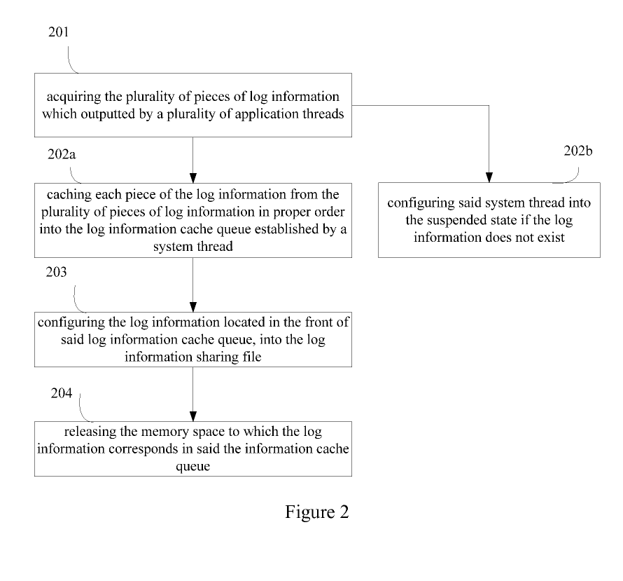

Further, the embodiments of the present disclosure disclose another method for outputting the log information; as shown in FIG. 2, the method includes:

201: acquiring the plurality of pieces of log information which have been outputted by the plurality of application threads.

Here, when each application thread runs, there may be a large amount of log information to be outputted. The log information is configured to record result data of various operations which have been performed in the process of running various application threads.

202a: caching each piece of the log information from the plurality of pieces of log information in proper order into the log information cache queue which has been established by the system thread.

Here, the system thread is configured to establish and maintain the log information cache queue. The log information cache queue may be configured to save the log information which has been outputted by different application threads, and the form whereby the log information is saved into the log information cache queue may specifically be the memory address to which the saved log information corresponds. The size of the log information cache queue can be specifically configured according to the memory size of the terminal device, and the specific data structure of the log information cache queue can be made with reference to the data structure in FIG. 1 and will not be described with unnecessary details here.

For the embodiments of the present disclosure, the operation in which the various application threads cache the log information, which has been outputted, into the log information cache queue may be performed in the memory. The time consumed for the caching operation in the memory is very short. Thus, this operation can significantly reduce the time consumed for the operation and further improve the task execution efficiency of the various threads. In comparison with the operation in which the various application threads directly configure the log information, the disclosed method manages the log information sharing file through a log information cache queue. The log information cache queue is a shared resource accessible to a plurality of threads. Thus, it may be necessary to add a mutual exclusion lock to the log information cache queue at the time of saving the log information into the log information cache queue and acquiring the log information from the log information cache queue so as to ensure the integrity of the operation of the shared resource. Perform the unlocking operation after having completed the operations.

For the embodiments of the present disclosure, as the time for the various application threads to output the log information may be subject to a chronological sequence. For example, the step 202a may include caching the each piece of the log information in a proper order into the log information cache queue in chronological order of the output time to which the each piece of log information corresponds. Here, the step of caching each piece of the log information into the log information cache queue which has been established by the system thread can specifically include: first configuring the mutual exclusion lock for the log information cache queue, then caching the log information into the log information cache queue which has been configured with the mutual exclusion lock and finally unlocking the log information cache queue.

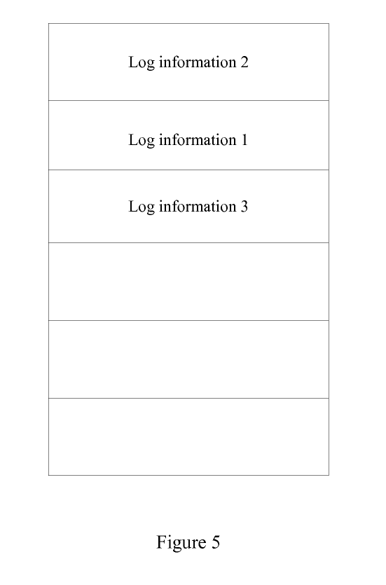

For example, there are three application threads, i.e., a thread 1, a thread 2 and a thread 3, which output the log information at present. The log information which is outputted respectively by the thread 1, the thread 2 and the thread 3 is log information 1, log information 2 and log information 3. After sorting the information according to the chronological sequence of the output time of each piece of log information, the sequence of the log information, which has been outputted, is the log information 2, the log information 1 and the log information 3, at this time, first configure the mutual exclusion lock for the log information cache queue, then cache the log information 2 into this log information cache queue, and finally unlock the log information cache queue; then cache the log information 1 and the log information 3 into the log information cache queue according to this mode. The sort order of each piece of log information in the log information cache queue at this time can be as shown in FIG. 5.

Step 202b in parallel with the step 202a: configuring the system thread into the suspended state if the log information does not exist.

Here, through configuring the system thread into the suspended state, it is feasible to conserve the system resources occupied by the system thread in order to provide more system resources for other application threads, so as to further improve the task execution efficiency of the various application threads.

Further, when this system thread judges that there is any application thread which performs the operation of caching into the log information cache queue, this system thread re-enters the normal operating status. Here, the application thread can wake up the system thread to enter the normal operating status by means of transmitting an enqueue prompt message to the system thread.

203: configuring the log information located in the front of the log information cache queue, into the log information sharing file.

Here, the log information sharing file may specifically be a device file or a regular file and may be configured to save the log information which has been outputted by various threads. The log information cache queue in the embodiments of the present disclosure may specifically be a first-in, first-out queue, so each time of acquiring the log information from the log information cache queue is to acquire one piece of log information from the front.

For the embodiments of the present disclosure, the process to realize the specific procedure of acquiring the log information from the log information cache queue can include: first adding the mutual exclusion lock to this log information cache queue prior to acquiring the log information from the log information cache queue, then extracting the log information from a queue array, the dequeue subscript position of which is “head,” adding 1 to the “head” value to make the pointer to the log information point to the dequeue position of the next piece of log information, and then unlocking the log information cache queue to complete this operation of acquiring the log information. When it is necessary to acquire the log information from the log information cache queue again, first add the mutual exclusion lock to this log information cache queue, then acquire the log information in the next dequeue position to which the abovementioned pointer to the log information points, add 1 to the “head” value again to make the pointer to the log information point to the dequeue position of the next piece of log information, and then unlock the log information cache queue to complete this operation of acquiring the log information. The rest can be done in the same manner until all the log information which has been cached into the log information cache queue is extracted.

Here, the step of determining whether any log information still exists in the log information cache queue or not can specifically include: after extracting the log information from a queue array, the dequeue subscript position of which is “head,” and adding 1 to the “head” value, first determining whether the current “head” value is equal to the maximum length of the array or not; if it is equal to the maximum length of the array, configuring the “head” value to 0, and then determining whether the “head” value is equal to the “tail” value or not; if it is unequal to the maximum length of the array, then directly determining whether the “head” value is equal to the “tail” value or not; when the “head” value is equal to the “tail” value, it is indicated that the dequeue operation of the log information has always been performed in this log information cache queue, but there is no enqueue operation of the new log information in the log information cache queue, or the amount of the log information for the dequeue operation is larger than the amount of the log information for the enqueue operation, and the difference between the amounts is equal to the upper limit of the amount of the log information which can be cached into the log information cache queue, which causes all the log information, which has been cached into the log information cache queue, to be extracted, and at this time, configuring an “empty” flag to “true” so as to identify that the current queue is empty. When the “head” value is unequal to the “tail” value, it is indicated that the amount of the log information for the enqueue operation and the amount of the log information for the dequeue operation are kept balanced in this cache queue, and at this time, configuring the “empty” flag to “false” so as to identify that the current log information cache queue is not empty and still caches the log information which can be acquired.

204: releasing the memory space to which the log information corresponds in the log information cache queue.

Here, through releasing the memory space to which the log information corresponds in the log information cache queue, it is feasible to provide the memory space, which saves the log information to be outputted, for other threads and to ensure the sustainability of the memory space of the log information cache queue.

The other method, which is disclosed in the embodiments of the present disclosure, for outputting the log information includes first acquiring the plurality of pieces of log information which have been outputted by the plurality of application threads, then caching each piece of the log information from the plurality of pieces of log information in proper order into the log information cache queue which has been established by the system thread and finally configuring the log information, which is located in the front of the log information cache queue, into the log information sharing file. In comparison with the current situation whereby the various threads directly configure their respectively outputted log information into the log information sharing file according to the certain order, i.e., when a certain thread is performing an operation of configuring the log information, which has been outputted, into the log information sharing file, other threads need to wait until this thread has completed the operation of configuring the log information into the log information sharing file and can then configure the log information into the log information sharing file again, the embodiments of the present disclosure establish and maintain one log information cache queue through the configuration of an independent system thread, acquire the log information from this log information cache queue through the system thread and configure the log information, which has been acquired, into the log information sharing file to make other threads be capable of executing other tasks immediately just after having cached the log information, which has been outputted, into this log information cache queue but not need to wait for the completion of the operation of configuring the log information, which has been outputted, into the log information sharing file prior to executing other tasks, so as to improve the task execution efficiency and performance of the various threads.

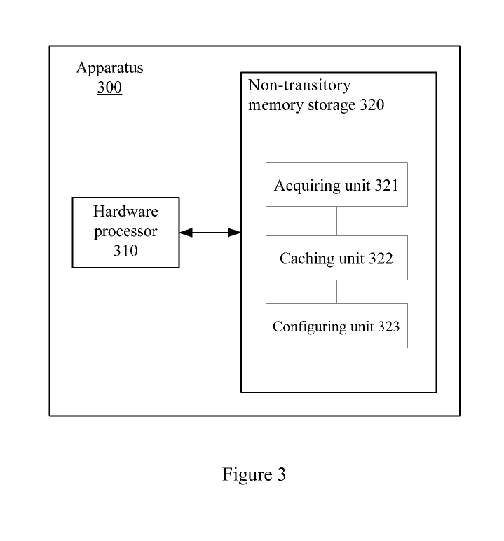

Further, as the specific realization of the method as shown in FIG. 1, the embodiments of the present disclosure disclose an apparatus 300 for outputting the log information; the apparatus can be applied to the terminal device, such as a cell phone, computer or notebook PC, and as shown in FIG. 3, the apparatus 300 includes a hardware processor 310 and a non-transitory storage medium 320 configured to store the following units implemented by the hardware processor: an acquiring unit 321, a caching unit 322 and a configuring unit 323.

The acquiring unit 321 may be configured to acquire the plurality of pieces of log information which have been outputted by the plurality of application threads.

The caching unit 322 may be configured to cache each piece of the log information from the plurality of pieces of log information, which have been acquired by the acquiring unit 321, in proper order into the log information cache queue which has been established by the system thread.

The configuring unit 323 may be configured to configure the log information, which is cached by the caching unit 322 and located in the front of the log information cache queue, into the log information sharing file.

It is necessary to state that other relevant descriptions of various functional units related to the apparatus, which is disclosed in the embodiments of the present disclosure, for outputting the log information can be made with reference to the corresponding description in FIG. 1 and will not be described with unnecessary details here.

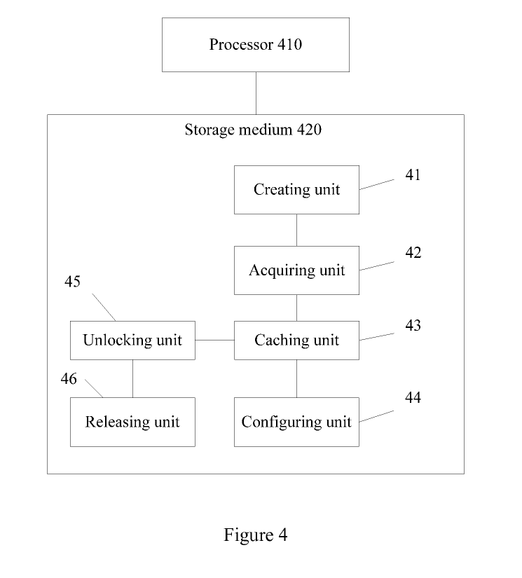

Yet further, as the realization of the method as shown in FIG. 2, the embodiments of the present disclosure disclose another apparatus for outputting the log information. The apparatus may be implemented in a terminal device, such as a cell phone, computer or notebook PC, and as shown in FIG. 4. The apparatus includes a hardware processor 410 and storage medium 420 configured to store the following units implemented by the hardware processor: an acquiring unit 41, a caching unit 42, a configuring unit 43, a creating unit 44, an unlocking unit 45, and a releasing unit 46. The storage medium 420 may be transitory or non-transitory.

The acquiring unit 41 may be configured to acquire the plurality of pieces of log information which have been outputted by the plurality of application threads.

The caching unit 42 may be configured to cache each piece of the log information from the plurality of pieces of log information, which have been acquired by the acquiring unit 41, in proper order into the log information cache queue which has been established by the system thread.

The configuring unit 43 may be configured to configure the log information, which is cached by the caching unit 42 and located in the front of the log information cache queue, into the log information sharing file.

The creating unit 44 may be configured to create the system thread, where the system thread is configured to establish and maintain the log information cache queue.

The caching unit 42 may be configured to cache the each piece of the log information in proper order into the log information cache queue in chronological order of the output time to which the each piece of log information corresponds.

The configuring unit 43 may be configured to configure the mutual exclusion lock for the log information cache queue.

The caching unit 42 may be configured to cache the log information into the log information cache queue which has been configured with the mutual exclusion lock.

The unlocking unit 45 may be configured to unlock the log information cache queue.

The configuring unit 43 may further be configured to configure the system thread into the suspended state if the log information does not exist.

The releasing unit 46 may be configured to release the memory space to which the log information corresponds in the log information cache queue.

It is necessary to state that other relevant descriptions of various functional units related to the apparatus, which is disclosed in the embodiments of the present disclosure, for outputting the log information can be made with reference to the corresponding description in FIG. 2 and will not be described with unnecessary details here.

The apparatus, which is disclosed in the embodiments of the present disclosure, for outputting the log information includes first acquiring the plurality of pieces of log information which have been outputted by the plurality of application threads, then caching each piece of the log information from the plurality of pieces of log information in proper order into the log information cache queue which has been established by the system thread and finally configuring the log information, which is located in the front of the log information cache queue, into the log information sharing file. In comparison with the current situation whereby the various threads directly configure their respectively outputted log information into the log information sharing file according to the certain order, i.e., when a certain thread is performing an operation of configuring the log information, which has been outputted, into the log information sharing file, other threads need to wait until this thread has completed the operation of configuring the log information into the log information sharing file and can then configure the log information into the log information sharing file again, the embodiments of the present disclosure establish and maintain one log information cache queue through the configuration of an independent system thread, acquire the log information from this log information cache queue through the system thread and configure the log information, which has been acquired, into the log information sharing file to make other threads be capable of executing other tasks immediately just after having cached the log information, which has been outputted, into this log information cache queue but not need to wait for the completion of the operation of configuring the log information, which has been outputted, into the log information sharing file prior to executing other tasks, so as to improve the task execution efficiency and performance of the various threads.

The apparatus that is disclosed in the embodiments of the present disclosure for outputting the log information can realize the embodiments of the method disclosed above. For the realization of specific functions, please refer to the descriptions in the embodiments of the method, and they will not be described with unnecessary details here. The method and the apparatus that are disclosed in the embodiments of the present disclosure for outputting the log information may be applied to, without limitation, the field of information technology.

Those of ordinary skill in the art may understand that the realization of the whole or partial flow in the method in the abovementioned embodiments may be completed through a computer program which instructs related hardware, the program may be stored in a computer-readable storage medium, and this program may include the flow of the embodiments of the abovementioned various methods at the time of execution. Here, the storage medium may be a disk, compact disk, read-only memory (ROM), or random access memory (RAM), etc. The embodiments described above are only a few example embodiments of the present disclosure, but the protective scope of the present disclosure is not limited to these. Any modification or replacement that can be easily thought of by those skilled in the present art within the technical scope disclosed by the present disclosure shall be covered by the protective scope of the present disclosure. Therefore, the protective scope of the present disclosure shall be subject to the protective scope of the claims.

What is claimed is:

1. A method for outputting log information, comprising:
acquiring, by a system thread in a terminal device having a processor, a plurality of pieces of log information from a plurality of application threads;
establishing, by the system thread, a log information cache queue,
caching, by the system thread, each piece of the log information from the plurality of pieces of log information into the established log information cache queue; and
configuring, by the system thread, the log information located in a front of the log information cache queue, into a log file.

2. The method of claim 1, wherein the method further comprises the following before acquiring the plurality of pieces of log information:
creating, by the terminal device, the system thread configured to establish and maintain the log information cache queue.

3. The method of claim 1, wherein caching each piece of the log information from the plurality of pieces of log information in proper order into the log information cache queue comprises:
caching the each piece of the log information in proper order into the log information cache queue in a chronological order of output time corresponding to each piece of log information.

4. The method of claim 3, wherein caching each piece of the log information into the log information cache queue comprises:
configuring a mutual exclusion lock for the log information cache queue;
caching the log information into the log information cache queue configured with the mutual exclusion lock; and
unlocking the log information cache queue.

5. The method of claim 1, wherein the method further comprises the following after acquiring the plurality of pieces of log information from the plurality of application threads:
configuring the system thread into a suspended state if the log information does not exist.

6. The method of claim 1, wherein the method further comprises the following after configuring the log information located in the front of the log information cache queue, into the log file:
releasing a memory space that the log information corresponds in the log information cache queue.

7. An apparatus for outputting log information, comprising a hardware processor and a non-transitory storage medium configured to store following modules implemented by the hardware processor:
an acquiring unit configured to acquire a plurality of pieces of log information outputted from a plurality of application threads;
a caching unit configured to cache each piece of the log information from the plurality of pieces of log information acquired by the acquiring unit into a log information cache queue established by a system thread; and
a configuring unit configured to configure the log information located in a front of the log information cache queue, into a log file.

8. The apparatus of claim 7, further comprising:
a creating unit configured to create the system thread, wherein the system thread is configured to establish and maintain the log information cache queue.

9. The apparatus of claim 7, wherein the caching unit is configured to cache the each piece of the log information in proper order into the log information cache queue in a chronological order of output time corresponding to each piece of log information.

10. The apparatus of claim 9, further comprising an unlocking unit, wherein:
the configuring unit is further configured to configure a mutual exclusion lock for the log information cache queue;
the caching unit is configured to cache the log information into the log information cache queue configured with the mutual exclusion lock; and
the unlocking unit is configured to unlock the log information cache queue.

11. The apparatus of claim 7, wherein the configuring unit is further configured to configure the system thread into a suspended state if the log information does not exist.

12. The apparatus of claim 7, further comprising:
a releasing unit configured to release a memory space that the log information corresponds in the log information cache queue.

13. A device for outputting log information, comprising a processor and a non-transitory storage medium accessible to the processor, the device is configured to:
establish a log information cache queue by a system thread in the device;
acquire a plurality of pieces of log information outputted from a plurality of application threads;
cache each piece of the log information from the plurality of pieces of log information into the log information cache queue; and
configure the log information located in a front of the log information cache queue, into a log file.

14. The device of claim 13, further configured to:
to create the system thread, wherein the system thread is configured to establish and maintain the log information cache queue.

15. The device of claim 13, further configured to cache the each piece of the log information in proper order into the log information cache queue in a chronological order of output time corresponding to each piece of log information.

16. The device of claim 15, further configured to:
configure a mutual exclusion lock for the log information cache queue;
cache the log information into the log information cache queue configured with the mutual exclusion lock; and
unlock the log information cache queue.

17. The device of claim 13, further configured to configure the system thread into a suspended state if the log information does not exist.

18. The device of claim 13, further configured to release a memory space that the log information corresponds in the log information cache queue.
